(19) United States
(12) Patent Application Publication
(10) Pub. No.: US 2023/0155188 A1
(43) Pub. Date: May 18, 2023

(54) DAMAGE DETECTOR FOR A RECHARGEABLE BATTERY

(71) Applicant: Hilti Aktiengesellschaft, Schaan (LI)

(72) Inventors: Varnim GOYAL, Landsberg am Lech (DE); Simon MÜLLER, Bobingen (DE); Bernd ZIEGLER, Schabmünchen (DE)

(21) Appl. No.: 17/529,491

(22) Filed: Nov. 18, 2021

(51) Int. Cl. H01M 10/44; H02J 7/00; H02J 7/04

(52) U.S. Cl. CPC H01M 10/44; H02J 7/0047; H02J 7/04; H01M 10/0525

(57) ABSTRACT

In one embodiment, a rechargeable battery, in particular as a power supply device for a power tool, has a rechargeable battery housing, at least one energy storage cell, a controller and a display. The rechargeable battery has a detector for detecting and a display for displaying a mechanical deformation on the rechargeable battery housing. A method for open-loop control and closed-loop control of the rechargeable battery is also provided. The method senses a mechanical deformation using the detection device and emits at least one signal using the detector for displaying the sensed mechanical deformation on the display device.

### BACKGROUND

The present invention relates to a rechargeable battery, in particular as a power supply device for a power tool.

The present invention furthermore relates to a method for open-loop control and closed-loop control of a rechargeable battery

### SUMMARY OF THE INVENTION

Modern power tools, such as hammer drills, saws, screwdrivers, grinders or the like, as well as rechargeable batteries, which can be connected to the power tool as a power supply, are usually very robust and exhibit hardly any damage or malfunctions after a fall or mishandling.

However, after a long fall from a particularly great height onto hard or unyielding ground, damage to the power tool and/or to a rechargeable battery that is connected to the power tool may well occur. Furthermore, it is also not unusual for the rechargeable battery to be handled improperly by a user. This can include, for example, the inappropriate use of the rechargeable battery as a hammer, for example for driving in nails.

This damage may not be directly visible or noticeable for a user of the power tool and/or the rechargeable battery. Damage to the power tool and/or the rechargeable battery that is not visible or not noticeable for a user may however represent a problem since the functionality or mode of operation of the power tool and/or the rechargeable battery may no longer exist. However, it is not always readily possible for a user to determine whether the situation of a rechargeable battery falling from a critical height or the use of the rechargeable battery as a hammer has caused damage to the rechargeable battery. Furthermore, it is also not always obvious to a user whether further use of the rechargeable battery is still sufficiently safe.

Apparatuses available on the market or already known from the prior art for sensing and displaying damage to a rechargeable battery are, however, often complex, expensive and frequently unreliable. In particular, apparatuses for sensing critical falling of a rechargeable battery having several acceleration sensors or several sensors which measure accelerations in different directions are problematic. Owing to the often large amount of measured acceleration values to be processed, however, unambiguous measurement results with reliable statements about the negative effects or possible damage sustained after a rechargeable battery has fallen can be generated all too seldom.

Furthermore, apparatuses of this kind are not able to sense possibly critical damage to, for example deformations on, the rechargeable batteries and accordingly to display to a user that prespecified threshold values for accelerations have not been reached. Despite low acceleration values, critical damage to the rechargeable battery may nevertheless have occurred.

It is therefore an object of the present invention to solve the problem described above and to provide a rechargeable battery in which critical damage can be sensed and displayed in a simple and reliable manner.

The present invention provides a rechargeable battery comprising:
a rechargeable battery housing;
at least one energy storage cell within the housing;
a controller;
a display connected to the controller; and
a detector for detecting a mechanical deformation on the rechargeable battery housing and connected to the controller.

According to one advantageous refinement of the present invention, it may be possible for the detector to be designed to detect a mechanical deformation on at least one first side wall of the rechargeable battery housing. Usually only a single side wall of the rechargeable battery housing exhibits damage in the form of deformations or deflections after the rechargeable battery has fallen or been used as a hammer. Consequently, by way of arranging the detector on at least one side wall of the rechargeable battery housing, space in and costs of the interior of the rechargeable battery housing can be saved.

In accordance with one advantageous refinement of the present invention, it may be possible for the detector to comprise at least one transmitter for emitting at least one signal, one transmission connection for transmitting at least one signal and one receiver for receiving a signal, wherein the transmitter, the transmission connection and the receiver are positioned in relation to one another such that at least one signal can be transmitted by the transmitter, via the transmission connection, to the receiver, wherein the transmission connection can be adjusted from a transmission state to a blocking state in the event of a deformation of the rechargeable battery housing. In this way, a mechanical deformation on the rechargeable battery housing that leads to an interruption or fault in the transmission connection and thus prevents proper signal transmission can be ascertained in a particularly efficient manner.

According to one advantageous refinement of the present invention, it may be possible for the transmission connection to be designed in the form of at least one optical waveguide. It is also possible here for several optical waveguides to be combined to form a bundle.

In accordance with one advantageous refinement of the present invention, it may be possible for the transmission connection in the form of a grating with at least one first and one second optical waveguide, wherein the first and the second optical waveguide are arranged substantially orthogonally in relation to one another. As a result, a mechanical deflection on the rechargeable battery housing can be ascertained as completely or almost as completely as possible.

According to one advantageous refinement of the present invention, it may be possible for the at least first and/or second optical waveguide to be designed in the form of a glass fiber conductor.

In accordance with one advantageous refinement of the present invention, it may be possible for the detector to comprise at least one pressure-sensitive conductor, which can be adjusted from an electrically non-conductive state to an electrically conductive state in the event of a deformation of the rechargeable battery housing. In the electrically conductive state, at least one electrical signal can be transmitted using the conductor.

According to one advantageous refinement of the present invention, it may be possible for the pressure-sensitive conductor to comprise at least one first conductor element, one second conductor element and one insulator, wherein the insulator is positioned in a direction between the first and the second conductor element in order to electrically insulate the first and the second conductor element from one another. In the event of a deformation on the rechargeable battery housing that leads to contact between the first and the second conductor element, an electrical signal can be transmitted from the first to the second conductor element. The insulator can prevent or delay direct contact between the first and the second conductor element. It is possible for the insulator to consist of an elastic material, so that the insulator is compressed by a mechanical deflection such that at least at certain points and at certain times there is no longer an insulating effect between the first and the second conductor element.

It is possible here for the first conductor element to be at a first electrical potential and the second conductor element to be at a second electrical potential that is different from the first. In the event of a deformation on the rechargeable battery housing that leads to contact between the first and the second conductor element, potential equalization can occur between the first and the second conductor element.

In accordance with one advantageous refinement of the present invention, it may be possible for the detector to be positioned at least on a lower side wall of the rechargeable battery housing. The positioning of the detector at least on a lower side wall of the rechargeable battery housing is advantageous since damage often occurs on the lower side wall of the rechargeable battery housing as a result of a fall or due to use as a hammer.

Furthermore, a method for open-loop control and closed-loop control of a rechargeable battery is provided, wherein the rechargeable battery comprises a rechargeable battery housing, at least one energy storage element, a control device, a memory device and a detector for detecting a mechanical deformation on the rechargeable battery housing.

According to the invention, the method comprises the method steps of:
sensing a mechanical deformation using the detector; and
emitting at least one signal using the detector for displaying the sensed mechanical deformation on a display.

In accordance with one advantageous refinement of the present invention, it may be possible for the rechargeable battery to be adjusted from a first operating state to a second operating state when the sensed deformation on the rechargeable battery housing has reached a predetermined threshold value. The predetermined threshold value may be a deformation on the rechargeable battery housing that corresponds to an elastic or plastic deflection of at least a portion of the rechargeable battery housing by a certain distance. The distance can correspond to between 5 and 10 mm, in particular 7 mm. In general, the distance can correspond to at least a wall thickness of the rechargeable battery housing.

According to one advantageous refinement of the present invention, it may be possible for electrical energy to be able to be received or delivered by the energy storage cells in the first operating state of the rechargeable battery and no electrical energy to be able to be received or delivered by the energy storage elements in the second operating state of the rechargeable battery. This makes it possible to ensure in a simple manner that the possibly damaged rechargeable battery can no longer be used. It is also possible here for the rechargeable battery to be able to be adjusted from the second operating state back to the first operating state merely by inputting a predetermined signal into the control device of the rechargeable battery. The predetermined signal may be a code or data sequence.

The present invention also provides a rechargeable battery comprising: a rechargeable battery housing having a side wall with a side wall thickness, the side wall having an inner surface; at least one energy storage cell within the rechargeable battery housing; and a detector spaced an activation distance from the inner surface, the activation distance being a function of the side wall thickness.

The present invention yet further provides a rechargeable battery comprising: a rechargeable battery housing having a side wall, the side wall having an inner surface; at least one energy storage cell within the rechargeable battery housing; and a detector having a transmitter, a transmission connection and a detector, the transmission connection having a surface facing inner surface and being parallel with respect to the inner surface.

### BRIEF DESCRIPTION OF THE DRAWINGS

Further advantages will become apparent from the following description of the figures. Various exemplary embodiments of the present invention are illustrated in the figures.

The figures, the description and the claims contain numerous features in combination. A person skilled in the art will expediently also consider the features individually and combine them to form useful further combinations.

In the figures, identical and similar components are denoted by the same reference signs. In the figures:

FIG. 1 shows a perspective view of a rechargeable battery;

FIG. 2 shows an exploded view of the rechargeable battery with an open rechargeable battery housing according to a first exemplary embodiment;

FIG. 3 shows a schematic sectional view of the rechargeable battery having a number of energy storage cells, a controller and a detector on the rechargeable battery housing in an intact state according to a first embodiment;

FIG. 4 shows a schematic sectional view of the rechargeable battery with a mechanical deformation on the rechargeable battery housing in a deformed state according to the first embodiment;

FIG. 5 shows an exploded view of the rechargeable battery with an open rechargeable battery housing according to a second exemplary embodiment;

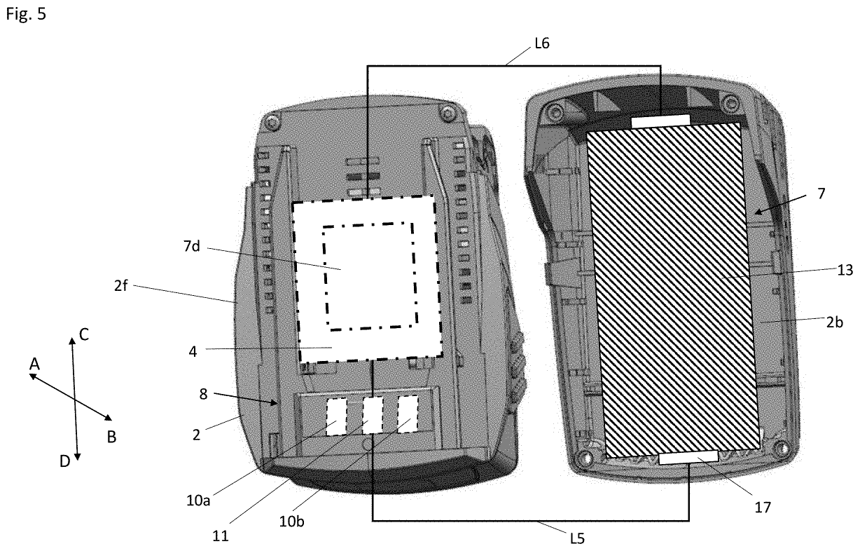

FIG. 6 shows a view of a detail of the detector according to a second embodiment with the rechargeable battery housing in an intact state;

FIG. 7 shows a view of a detail of the detector according to the second embodiment with the rechargeable battery housing in a deformed state;

FIG. 8 shows a view of a detail of the detector according to a third embodiment with the rechargeable battery housing in an intact state; and

FIG. 9 shows a view of a detail of the detector according to the third embodiment with the rechargeable battery housing in a deformed state.

### DETAILED DESCRIPTION

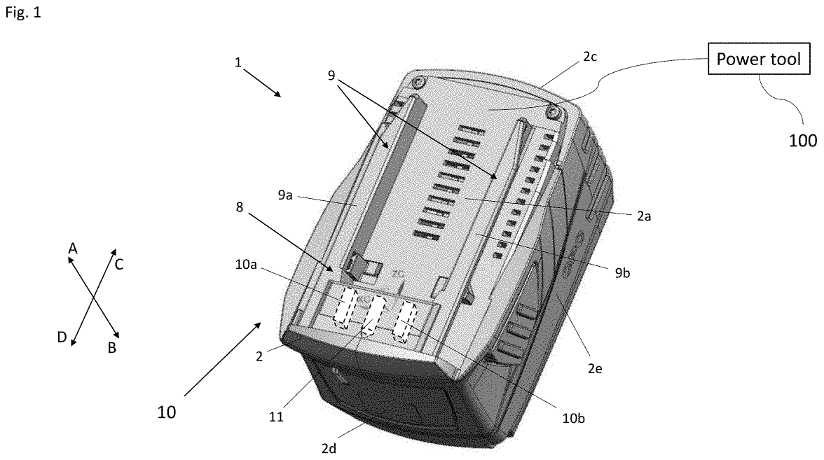

FIG. 1 shows a rechargeable battery 1 according to the invention in line with an exemplary embodiment. Rechargeable battery 1 can serve as a power supply for a power tool 100 (shown schematically here). The power tool may be a hammer drill, a saw, a screwdriver, a grinder or the like.

Rechargeable battery 1 substantially comprises a rechargeable battery housing 2, a number of energy storage cells 3, a controller 4, a memory 5, a display 6 and a detector 7.

Rechargeable battery housing 2 is substantially designed as a container with an internal volume and here has a top side 2a, a bottom side 2b, a front side 2c, a rear side 2d, a left-hand side wall 2e and a right-hand side wall 2f.

Display 6 is positioned on front side 2c of rechargeable battery housing 2. Display 6 can also be referred to as a display or screen and serves to visually reproduce or display information. In the present exemplary embodiment, display 6 is designed in the form of an LED lamp that can light up red. As described in more detail below, display 6 lights up red in the event of a deformation on the rechargeable battery housing 2.

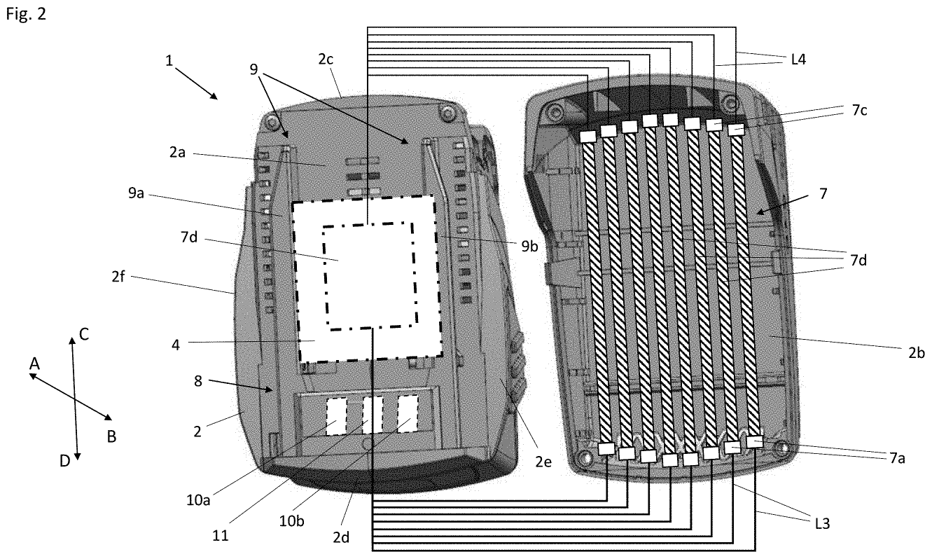

As can be seen in FIGS. 1 and 2 in particular, an interface 8 is positioned on the top side 2a of the rechargeable battery housing 2 in arrow direction A. Interface 8 in turn comprises a mechanical connector 9, an electrical connector 10 and a communication device 11.

As shown in FIGS. 1 and 2, mechanical connector 9 is designed substantially in the form of a first and a second rail 9a, 9b. Rechargeable battery 1 can be releasably connected to a power tool or a charging apparatus via first and second rails 9a, 9b, in particular the rechargeable battery 1 can thereby be pushed in arrow direction C onto a corresponding interface on a power tool or charger.

Electrical connector 10 substantially comprises a positive pole connection 10a and a negative pole connection 10b for receiving electrical energy at a charging apparatus or for delivering electrical energy to a power tool. As indicated in FIGS. 1 and 2, positive pole connection 10a and negative pole connection 10b are arranged next to one another between first and second rails 9a, 9b.

Communication device 11 is substantially designed in the form of a plug and serves primarily to receive and emit electrical signals. Information and data in the form of electrical signals can be exchanged between rechargeable battery 1 and the power tool or changer via communication device 11. As is likewise indicated in FIGS. 1 and 2, communication device 11 is arranged between positive pole connection 10a and negative pole connection 10b.

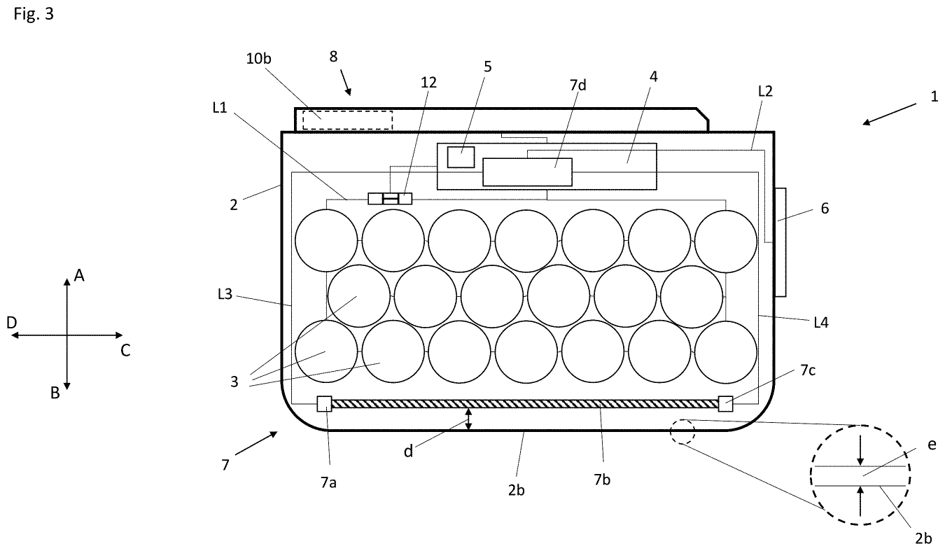

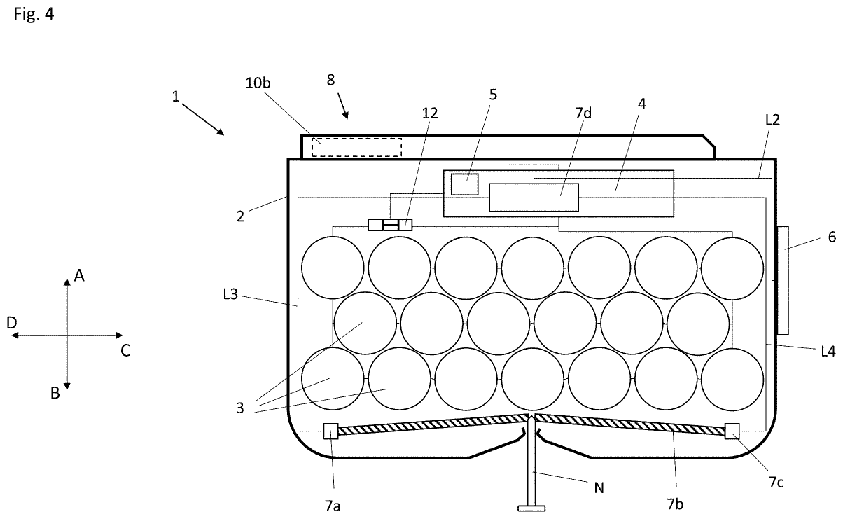

In the present exemplary embodiment, twenty energy storage cells 3 are arranged in an interior space in the interior of the rechargeable battery housing 2 in three rows in arrow direction C or D, cf. FIGS. 3 and 4.

According to alternative embodiments of the rechargeable battery 1, however, more or fewer than twenty energy storage cells 3 in more or fewer than three rows can also be used.

Energy storage cells 3 serve to receive, store and deliver electrical energy. As shown in FIGS. 3 and 4, individual energy storage cells 3 are connected to the control device 4 via corresponding first lines L1 to form an electrical circuit such that the electrical energy stored in energy storage cells 3 can either pass from energy storage cells 3 to controller 4 for a discharge process or electrical energy can pass from controller 4 to the energy storage cells 3 for a charging process.

A protective apparatus 12 is positioned in the line L1 at one point.

In the present exemplary embodiment, protective apparatus 12 is designed in the form of a current interruption unit. The current interruption unit can also be referred to as an electrical fuse or OCP (=Over Current Protection) here and serves to interrupt the line L1, so that no more electrical energy can pass from or to the energy storage cells 3.

In the present exemplary embodiment, energy storage cells 3 are based on lithium-ion (Li-ion) technology. As an alternative, energy storage cells 3 can, however, also be based on a lithium cobalt dioxide (LiCoO₂), lithium polymer (LiPo), lithium manganese (Li—Mn), lithium nickel cobalt manganese (Li(NiCoMn)O2), lithium iron phosphate (LiFePO₄), lithium titanate (LiTi), lithium metal polymer (LMP) technology.

However, it is also possible here for energy storage cells 3 with different technologies to be used in a rechargeable battery 1.

In the present exemplary embodiment, energy storage cells 3 are illustrated in cylindrical form. As an alternative, energy storage cells 3 can, however, also be designed as pouch cells, which can also be referred to as pouch bag cells or coffee bag cells.

As shown in FIGS. 3 and 4, controller 4 is arranged in the vicinity of or in arrow direction B below the top side 2a of the rechargeable battery housing 2. Controller 4 substantially serves for open-loop control, closed-loop control and monitoring of the functions of rechargeable battery 1. These functions include, amongst other things, monitoring the delivery or receiving of electrical energy by energy storage cells 3. Controller 4 also contains memory 5, which serves to store various data and information, in particular in connection with a function or a process within the rechargeable battery 1. Therefore, amongst other things, threshold values, such as for the deformation of rechargeable battery housing 2, are stored in memory 5.

FIGS. 2 to 4 illustrate detector 7 according to a first embodiment, wherein the detector 7 substantially comprises a number of transmitters 7a, transmission connections 7b, receivers 7c and a controller 7d.

Protective apparatus 12 is connected to the control unit 7d such that protective apparatus 12 can be activated by controller 7d, i.e. line L1 between the energy storage cells 3 and controller 4 can be interrupted.

Controller 7d is likewise connected to display 6 via a second line L2, so that the reproduction of corresponding information via display 6 can be controlled using the controller 7d.

As indicated in FIGS. 2 to 4, eight transmitters 7a, eight transmission connections 7b and eight receivers 7c are provided in the present exemplary embodiment. Controller 7d is contained in the controller 4.

According to an alternative embodiment of the rechargeable battery 1, more or fewer than eight transmitters 7a, eight transmission connections 7b and eight receivers 7c can also be provided.

In accordance with a special exemplary embodiment, the detection device 7 can contain only a transmitter 7a, a transmission connection 7b and a receiver 7c.

According to the exemplary embodiment illustrated, respective transmitter 7a and receiver 7c are positioned opposite one another on an inner side of rechargeable battery housing 2. A respective transmission connection 7b is arranged between each transmitter 7a and receiver 7c, or transmitter 7a and receiver 7c are connected to one another by a respective transmission connection 7b. Here, transmission connection 7b is situated as close as possible to, i.e. at a mean distance d from, the inner side of rechargeable battery housing 2. In the exemplary embodiment illustrated, the distance d is 5 mm. As an alternative, the distanced can also be less or more than 5 mm. In general, it is important to choose the distance d as a function of the wall thickness e of the rechargeable battery housing 2. The greater the wall thickness e of the rechargeable battery housing 2, the closer transmission connection 7b has to be positioned to the inner side of the rechargeable battery housing 2 in arrow direction B, i.e. the smaller the distance d has to be selected to be. In the present exemplary embodiment, the wall thickness e has a value of 3 mm.

As illustrated in FIGS. 2 to 4, the transmitters 7a, transmission connections 7b and receivers 7c are arranged in the vicinity of the inner surface of bottom side 2b of rechargeable battery housing 2.

As an alternative, the transmitters 7a, transmission connections 7b and receivers 7c can also be arranged in the vicinity of the inner surface of a side wall 2c, 2d or in the vicinity of the inner surface of the top side 2a of the rechargeable battery housing 2.

Transmitter 7a, transmission connection 7b and also receiver 7c are each designed such that electrical signals can be transmitted from a transmitter 7a, through a transmission connection 7b, to a receiver 7c. Each transmitter 7a is connected to controller 7d via a transmitter line L3 and each receiver 7c is connected to controller 7d via a receiver line L4. Transmitter line L3 serves to transmit signals from the controller 7d to respective transmitter 7a. In a similar way, receiver line L4 serves to transmit signals from respective receiver 7c to controller 7d. Controller 7d, transmitter line L3, transmitter 7a, transmission medium 7b, receiver 7c and receiver line L4 are combined to form a circuit. The circuit can also be referred to as an electrical circuit here since signals can be transmitted in the form of electrical signals.

In the present exemplary embodiment, the transmission connection 7b is designed in the form of an optical waveguide.

FIG. 3 shows a rechargeable battery 1 in an intact state with an undamaged rechargeable battery housing 2. In this context, intact or undamaged means that there is no or only minimal deformation on the rechargeable battery housing 2. In this context, minimal deformation means that the deformation is less than a predetermined threshold value. The threshold value for a critical deformation on rechargeable battery housing 2 corresponds, is a distance of a plastic or elastic deflection of a portion (e.g. the bottom side) of rechargeable battery housing 2 that corresponds to at least a wall thickness e of rechargeable battery housing 2.

As can be seen, transmission connection 7b designed as optical waveguides run substantially in a straight line in arrow direction C or D between transmitter 7a and receiver 7c or parallel to the bottom side 2b of the rechargeable battery housing 2.

FIG. 4 illustrates a situation in which a pointed object N, i.e. a nail, passes through bottom side 2b of rechargeable battery housing 2 in arrow direction A into the interior of rechargeable battery housing 2. The entry of nail 13 results in a deformation of bottom side 2b of rechargeable battery housing 2 that is greater than a deflection threshold value. In other words: the distance of the deformation in arrow direction A is greater than wall thickness e of the rechargeable battery housing 2. As a result of this critical deformation, transmission connection 7b designed as optical waveguides are bent and also damaged. Due to the damage to the optical waveguide as the transmission connection 7b, no more signals are conducted from transmitter 7a to receiver 7c. The control unit 7d recognizes that signals are emitted to transmitters 7a, but a corresponding signal is no longer received at one or more receivers 7c. In this way, damage in the form of a deformation on rechargeable battery housing 2, which deformation also leads to damage to transmission connection 7b, is detected.

As a result of recognizing the critical deformation on rechargeable battery housing 2 and on the transmission connection 7b, controller 7d transmits a corresponding signal to protective apparatus 12 designed as a fuse in order to activate the protective apparatus 12 and to interrupt the line L1. As already mentioned above, the interruption of line L1, no more electrical energy can pass from or to the energy storage cells 3.

Similarly, recognizing the critical deformation on rechargeable battery housing 2 and on transmission media 7b, a corresponding signal is transmitted from controller 7d to display 6, so that a critical deformation the rechargeable battery housing 2 and a subsequent interruption of line L1 (i.e. an interruption in receiving or delivery of electrical energy from or to the energy storage cells 3) is displayed to a user, not shown, via a corresponding signal (i.e. in this case an LED that lights up red) on display 6.

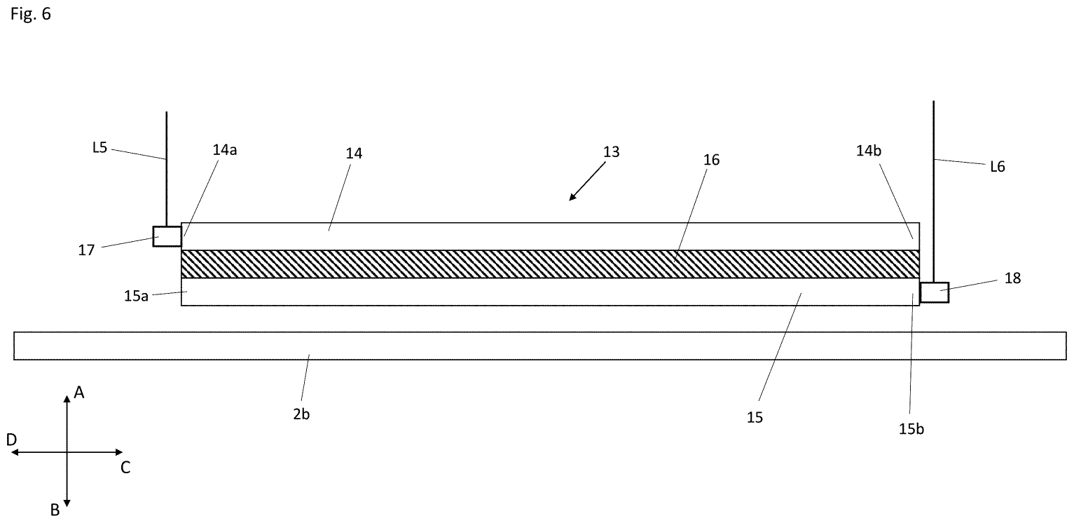

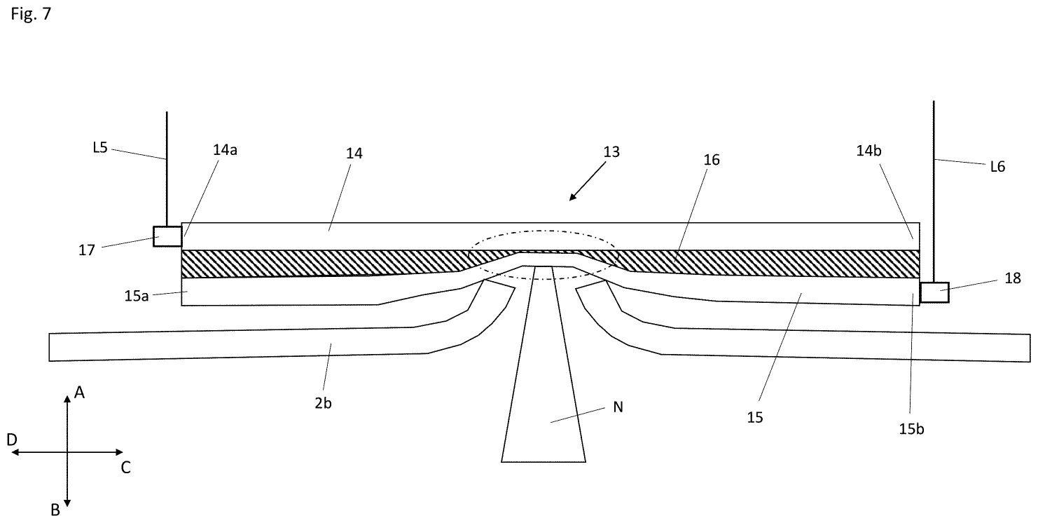

FIGS. 6 and 7 illustrate detector 7 for detecting a mechanical deformation on rechargeable battery housing 2 according to a second embodiment.

Here, detector 7 comprises a pressure-sensitive conductor 13, which is adjusted from an electrically non-conductive state to an electrically conductive state in the event of a deformation of rechargeable battery housing 2. Conductor 13 in turn comprises a first conductor element 14, a second conductor element 15 and an insulator 16. Both first and second conductor elements 14, 15 consist of an electrically conductive material. In the present exemplary embodiment, first and second conductor elements 14, 15 substantially consist of copper. First conductor element 14 furthermore has a first end 14a and a second end 14b. A connection 17 is provided at first end 14a of first conductor element 14, as a result of which the controller 7d is connected to first conductor element 14 via a first power line L5. An electrical potential is applied to first conductor element 14 using the first power line L5. In the present exemplary embodiment, the electrical potential is 5 mV.

Second conductor element 15 likewise has a first end 15a and a second end 15b. A connection 18 is provided at the second end 15b of the second conductor element 15, as a result of which the controller 7d is connected to the second conductor element 15 via a second power line L6.

As shown in FIG. 6, insulator 16 is positioned between the first and the second conductor element 14, 15, so that first conductor element 14 is electrically insulated from second conductor element 15 and no electric current can pass from first conductor element 14 to second conductor element 15 in an undamaged or intact state of the rechargeable battery housing 2. FIG. 6 illustrates conductor 13 in an intact or undeformed state of rechargeable battery housing 2, wherein no current from first conductor element 14 to second conductor element 15 or no potential equalization takes place between first conductor element 14 and second conductor element 15.

FIG. 7 shows conductor 13 in a damaged or deformed state of rechargeable battery housing 2 illustrated, wherein a pointed object N (i.e. a nail) passes through bottom side 2b into the interior of rechargeable battery housing 2 and in arrow direction A meets second conductor element 15. When the pressure or the force of the penetrating object N reaches a specific threshold value, i.e. is high enough, second conductor element 15 is pressed against first conductor element 14 in arrow direction A. Due to the sufficient force, insulating element 16, owing to its nature, is compressed at one point such that first and second conductor element 14, 15 are so close to one another that current can pass from first conductor element 14 to second conductor element 15 and as a result potential equalization takes place between the first and the second conductor element 14, 15. Electric current is conducted from second conductor element 15 to controller 7d using the second power conductors L6. This informs the controller 7d that first and second conductor elements 14, 15 have been brought into contact or almost brought into contact and there is deformation on rechargeable battery housing 2. As a result of this, controller 7d transmits a corresponding signal to protective apparatus 12 in order to interrupt the first line L1.

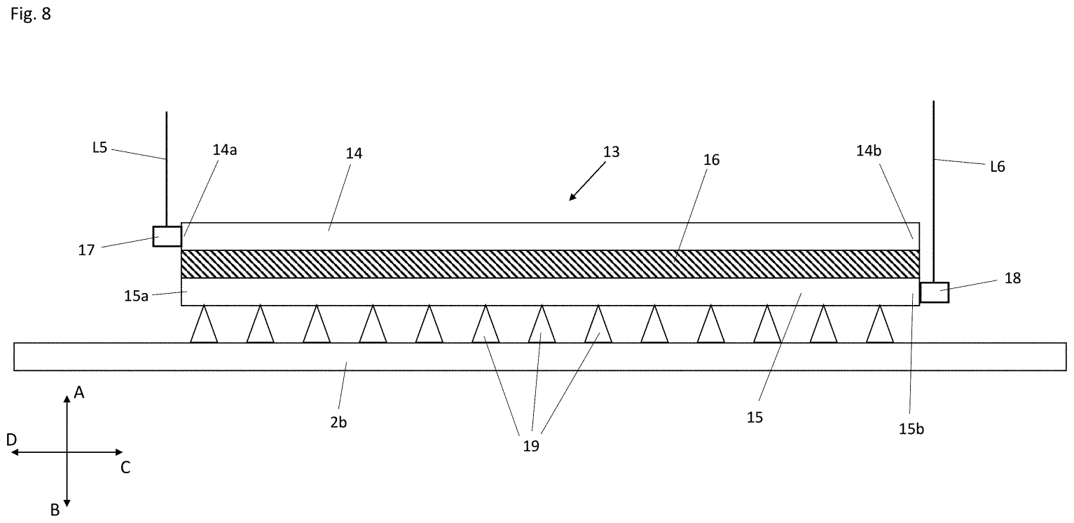

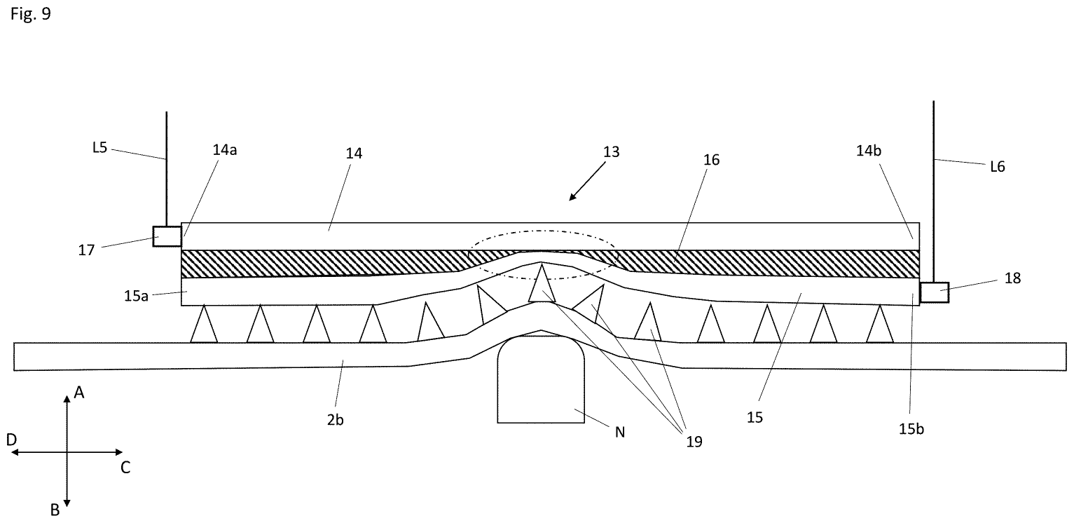

FIGS. 8 and 9 illustrate detector 7 for detecting a mechanical deformation on the rechargeable battery housing 2 according to a third embodiment. Detector 7 according to the third embodiment is almost identical to detector 7 according to the second embodiment. In contrast to detector 7 according to the second embodiment, detector 7 according to the third embodiment comprises additional a number of projections 17. As indicated in FIGS. 8 and 9, projections 17 are arranged on the inner side of the bottom side 2b of rechargeable battery housing 2, so that the respective tips of the projections 17 point in arrow direction A. Projections 17 substantially serve to press second conductor element 15 through the insulator 16 onto first conductor element 14 at certain points when an object N presses against the bottom side 2b in arrow direction A but the bottom side 2b of rechargeable battery housing 2 is deformed only to a small degree or not to a sufficient extent and detector 7 is nevertheless intended to sense a possibly critical deformation on the rechargeable battery housing.

### LIST OF REFERENCE SIGNS

1 Rechargeable battery
2 Rechargeable battery housing
2a Top side of the rechargeable battery housing
2b Bottom side of the rechargeable battery housing
2c Front side of the rechargeable battery housing
2d Rear side of the rechargeable battery housing
2e Left-hand side wall of the rechargeable battery housing
2f Right-hand side wall of the rechargeable battery housing
3 Energy storage cell
4 Controller
5 Memory
6 Display
7 Detector
7a Transmitter
7b Transmission medium
7c Receiver
7d Controller
8 Interface
9 Mechanical connector
9a First rail
9b Second rail
10 Electrical connector
10a Positive pole connection
10b Negative pole connection
11 Communication device
12 Protective apparatus
13 Conductor
14 First conductor element
14a First end of the first conductor element
14b Second end of the first conductor element
15 Second conductor element
15a First end of the second conductor element
15b Second end of the second conductor element
16 Insulator
17 Projections
L1 First line
L2 Second line
L3 Transmitter line
L4 Receiver line
L5 First power line
L6 Second power line
e Wall thickness of the rechargeable battery housing
d Distance between the transmission connection and the inner side of the rechargeable battery housing
N Deforming object

What is claimed is:

1. A rechargeable battery comprising:
a rechargeable battery housing;
at least one energy storage cell within the housing;
a controller;
a display connected to the controller; and
a detector for detecting a mechanical deformation on the rechargeable battery housing and connected to the controller.

2. The rechargeable battery as claimed in claim 1 wherein the detection device is designed to detect a mechanical deformation on at least a first side wall of the rechargeable battery housing.

3. The rechargeable battery as claimed in claim 1 wherein the detector includes at least one transmitter for emitting at least one signal, one transmission connection for transmitting at least one signal and one receiver for receiving a signal, wherein the transmitter, the transmission connection and the receiver are positioned in relation to one another such that at least one signal is transmittable by the transmitter, via the transmission medium, to the receiver, wherein the transmission connection is adjustable from a transmission state to a blocking state in the event of a deformation of the rechargeable battery housing.

4. The rechargeable battery as claimed in claim 1 wherein the transmission connection is designed in the form of at least one optical waveguide.

5. The rechargeable battery as claimed in claim 1 wherein the transmission connection is in the form of a grating with at least one first and one second optical waveguide, wherein the first and the second optical waveguide are arranged orthogonally in relation to one another.

6. The rechargeable battery as claimed in claim 4 wherein the at least first or second optical waveguide is designed in the form of a glass fiber conductor.

7. The rechargeable battery as claimed in claim 1 wherein the detector includes at least one pressure-sensitive conductor adjustable from an electrically non-conductive state to an electrically conductive state in the event of a deformation of the rechargeable battery housing.

8. The rechargeable battery as claimed in claim 7 wherein the pressure-sensitive conductor apparatus includes at least one first conductor element, one second conductor element and one insulator, wherein insulator is positioned in a direction between the first and the second conductor element in order to electrically insulate the first and the second conductor element from one another.

9. The rechargeable battery as claimed in claim 1 wherein the detector is positioned at least on a lower side wall of the rechargeable battery housing.

10. A method for open-loop control and closed-loop control of a rechargeable battery as claimed in claim 1, the method comprising the steps of:
sensing the mechanical deformation using the detection device; and
emitting at least one signal using the detector for displaying the sensed mechanical deformation on the display.

11. The method as claimed in claim 10, further comprising adjusting the rechargeable battery from a first operating state to a second operating state when the sensed mechanical deformation on the rechargeable battery housing has reached a predetermined threshold value.

12. The method as claimed in claim 11 wherein electrical energy is receivable or deliverable by the energy storage cells in the first operating state of the rechargeable battery and no electrical energy is receivable or deliverable by the energy storage cells in the second operating state of the rechargeable battery.

13. A power tool comprising the rechargeable battery as recited in claim 1.

14. A rechargeable battery comprising:
a rechargeable battery housing having a side wall with a side wall thickness, the side wall having an inner surface;
at least one energy storage cell within the rechargeable battery housing; and
a detector spaced an activation distance from the inner surface, the activation distance being a function of the side wall thickness.

15. A rechargeable battery comprising:
a rechargeable battery housing having a side wall, the side wall having an inner surface;
at least one energy storage cell within the rechargeable battery housing; and
a detector having a transmitter, a transmission connection and a detector, the transmission connection having a surface facing inner surface and being parallel with respect to the inner surface.
